(19) United States
(12) Patent Application Publication
(10) Pub. No.: US 2013/0122345 A1
(43) Pub. Date: May 16, 2013

(54) ELECTRODE LEAD CONNECTION BODY, NONAQUEOUS ELECTROLYTE ELECTRICITY STORING DEVICE AND METHOD OF MANUFACTURING THE SAME

(71) Applicants: Takumi SATO, Hitachi (JP); Yuju Endo, Hitachi (JP); Kenichi Murakami, Hitachi (JP); Hiroaki Komatsu, Hitachi (JP)

(72) Inventors: Takumi SATO, Hitachi (JP); Yuju Endo, Hitachi (JP); Kenichi Murakami, Hitachi (JP); Hiroaki Komatsu, Hitachi (JP)

(73) Assignee: Hitachi Cable, Ltd., Tokyo (JP)

(21) Appl. No.: 13/612,659

(22) Filed: Sep. 12, 2012

(30) Foreign Application Priority Data
Nov. 11, 2011 (JP) 2011-247353

(51) Int. Cl. H01B 5/00; H01G 9/00; H01M 2/20

(52) U.S. Cl. 429/121; 29/25.03; 174/126.1

(57) ABSTRACT

An electrode lead connection body includes a first member that includes a same material as the positive electrode lead and is configured to be connected the positive electrode lead, a second member that includes a same material as the negative electrode lead and is configured to be connected the negative electrode lead, the first and second members being joined to each other at a portion excluding a positive electrode joint as a portion to be joined to the positive electrode lead and a negative electrode joint as a portion to be joined to the negative electrode lead, and an insulating material at a position between the first and second members and near a joint portion to join the first and second members so as to prevent a contact between the first and second members.

The present application is based on Japanese patent application No. 2011-247353 filed on Nov. 11, 2011, the entire contents of which are incorporated herein by reference.

### BACKGROUND OF THE INVENTION

1. Field of the Invention

The invention relates generally to an electrode lead connection body for electrically connecting a positive electrode lead connected to a positive electrode of a battery cell with a negative electrode lead connected to a negative electrode of another battery cell. Also, the invention relates to a nonaqueous electrolyte electricity storing device and a method of manufacturing the nonaqueous electrolyte electricity storing device.

2. Related Art

In recent years, nonaqueous electrolyte secondary batteries as typified by lithium-ion secondary battery have been developed for practical use. Since an energy output per unit volume (unit mass) of the nonaqueous electrolyte secondary battery is higher than that of other batteries such as lead battery, it has been progressively used in mobile communication devices, notebook computers, electric vehicles, hybrid vehicles and electric power storage systems using renewable energy such as solar cell.

To manufacture a battery cell of nonaqueous electrolyte secondary battery, an electrode group having a laminated structure in which a separator is arranged between positive and negative electrodes is made and is placed in an outer package, and then, an electrolytic solution is encapsulated in the outer package. Al is used as a base material of the positive electrode and Cu is used as a base material of the negative electrode. Electrode leads are connected to the positive and negative electrodes to electrically connect to another battery cell or a control unit. Metals constituting the electrode lead are Al for the electrode lead connected to the positive electrode (a positive electrode lead) and Cu or Ni for the electrode lead connected to the negative electrode (a negative electrode lead).

In some devices such as mobile communication devices, such a nonaqueous electrolyte secondary battery is used alone. However, output of a single battery cell is obviously not enough for devices requiring significant power such as electric vehicle, and accordingly, plural battery cells are connected in series to obtain desired electrical energy. In this case, it is necessary to connect a positive electrode lead to a negative electrode lead, which means that dissimilar metals must be joined since Al is used for the positive electrode lead and Cu or Ni is used for the negative electrode lead as described above. In the case of joining dissimilar metals, there is concern about corrosion at a joint due to a local cell effect caused by difference in ionization tendency between the metals. In addition, joining itself has a problem that stable joint strength is difficult to be obtained by resistance welding as a general metal joining due to a difference between melting points of the respective metals. Furthermore, when plural battery cells are combined in order to efficiently discharge and charge, it is necessary to monitor a state, generally voltage, of each battery cell and a wiring therefor needs to be provided in each space between the battery cells. Therefore, for assembling a nonaqueous electrolyte electricity storing device (battery module), for example, a positive electrode lead as an Al material is joined to a Ni plate by applying ultrasonic wave in a state of a single battery cell so as to have enough connection workspace, the Ni plate is subsequently resistance-welded to a negative electrode lead as a Ni material of another battery cell to complete a nonaqueous electrolyte electricity storing device and a voltage monitoring lead wire is then soldered to the battery cells in each space therebetween, i.e., three different joining methods are used in total to assemble the nonaqueous electrolyte electricity storing device and it is thus complicated.

In addition to this, there is a method of assembling a nonaqueous electrolyte electricity storing device by arranging a Ni plate between electrode leads of battery cell and then electrically connecting therebetween using a mechanical fastening mechanism such as bolt, however, it arises problems that downsizing of a nonaqueous electrolyte electricity storing device is impeded and contact resistance increases due to uneven fastening torque (screw tightening torque) or looseness of the fastening mechanism during actual use.

Meanwhile, JP-A-2008-108584 discloses a lead member (electrode lead) in which first and second members respectively formed of the same metals as the positive and negative electrodes, i.e., formed of Al and Cu, are joined at an overlapped portion therebetween by cold rolling and the overlapped portion is covered by a corrosion-resistant material. In this lead member, it is possible to obtain mechanically sufficient joint strength and corrosion of the joint portion can be prevented by a cover which blocks external air. When this lead member is used as a positive or negative electrode lead of battery cell, the same metals are joined for connection of electrodes between battery cells and it is therefore possible to adopt a simpler method such as, e.g., resistance welding without occurrence of corrosion due to the local cell effect in principle.

In addition to this, for example, Japanese patent No. 3931983 and JP-A-2004-247244 disclose a structure in which a Cu plate is joined to an Al plate as a positive electrode lead member by laser welding and the joint portion therebetween is covered with a resin.

### SUMMARY OF THE INVENTION

With respect to JP-A-2008-108584, since the lead member overlaps with a sealed portion of the outer package at a corrosion-resistant material portion covering the joint portion between the first and second members of and is thus thicker than a lead member not being covered, it is considered difficult to obtain sufficient sealing properties in a process of thermally sealing the outer package and there is concern about leakage of electrolytic solution.

With respect to Japanese patent No. 3931983 and JP-A-2004-247244, although a resin-covered portion formed by covering a joint between dissimilar metals of the lead member is located outside of the outer package, there is concern that the resin-covered portion is damaged by contact with a manufacturing tool during the process of thermally sealing the outer package at the time of manufacturing a battery cell and design limitation is imposed such that a length of an electrode lead portion from an edge of the outer package to an edge of the resin-covered portion is increased to be larger than the size of the manufacturing tool, which arises problems in downsizing and thinning of a nonaqueous electrolyte electricity storing device. In addition, when the electrode lead portion is joined to a dissimilar metal and is covered with a resin after manufacturing the battery cell, workability for covering the resin in a form of assembled battery after connection is poor and defective products causes great loss, which affects not only the lead member but also the battery cell or more.

Accordingly, it is an object of the invention to provide an electrode lead connection body which allows mechanically sufficient joint strength or joint reliability (long-term joint stability) to be obtained even when connecting positive and negative electrode leads formed of different metals and also allows simplification of an assembly process of a nonaqueous electrolyte electricity storing device and secure connection and downsizing thereof, as well as to provide a nonaqueous electrolyte electricity storing device and a method of manufacturing the nonaqueous electrolyte electricity storing device.

(1) According to one embodiment of the invention, an electrode lead connection body for being arranged between a positive electrode lead and a negative electrode lead to electrically connect the positive electrode lead and the negative electrode lead such that the positive electrode lead is connected to a positive electrode of one battery cell and the negative electrode lead is connected to a negative electrode of another battery cell different from the one battery cell, the negative electrode lead comprising a metal different from the positive electrode lead comprises:

a first member that comprises a same material as the positive electrode lead and is configured to be connected the positive electrode lead;

a second member that comprises a same material as the negative electrode lead and is configured to be connected the negative electrode lead, the first and second members being joined to each other at a portion excluding a positive electrode joint as a portion to be joined to the positive electrode lead and a negative electrode joint as a portion to be joined to the negative electrode lead; and

an insulating material at a position between the first and second members and near a joint portion to join the first and second members so as to prevent a contact between the first and second members.

In the above embodiment (1) of the invention, the following modifications and changes can be made.

(i) The first and second members each comprise an electrode welding hole and a protruding portion provided at a rim of the electrode welding hole.

(ii) The first member comprises Al, and the second member comprises Cu, Ni or Ni-plated Cu.

(2) According to another embodiment of the invention, a nonaqueous electrolyte electricity storing device comprises:

the electrode lead connection body according to the above embodiment (1); and

a plurality of battery cells each having a positive electrode lead and a negative electrode lead,

wherein the plurality of battery cells are connected such that the first member of the electrode lead connection body is joined to the positive electrode lead of one battery cell and the second member of the electrode lead connection body is joined to the negative electrode lead of another battery cell different from the one battery cell.

(3) According to another embodiment of the invention, a method of manufacturing a nonaqueous electrolyte electricity storing device comprises:

joining the first member of the electrode lead connection body according to the above embodiment (1) to the positive electrode lead of one battery cell and joining the second member of the electrode lead connection body to the negative electrode lead of another battery cell different from the one battery cell so as to connect a plurality of battery cells.

(4) According to another embodiment of the invention, a method of manufacturing a nonaqueous electrolyte electricity storing device comprises:

inserting a positive terminal of one battery cell into an electrode welding hole provided on the first member of the electrode lead connection body according to the above embodiment (1) and inserting a negative terminal of another battery cell different from the one battery cell into an electrode welding hole provided on the second member of the electrode lead connection body; and

welding to the positive terminal and the negative terminal a side surface of a protruding portion provided at a rim of the electrode welding holes, respectively, so as to connect a plurality of battery cells.

### POINTS OF THE INVENTION

According to one embodiment of the invention, an electrode lead connection body is constructed such that a first member and a second member thereof are joined to each other at a portion excluding a positive electrode joint and a negative electrode joint, and an insulating material is interposed between the first member and the second member so as to prevent the first member from contacting with the second member except at a jointed portion of the first and second members. Thereby, it is possible to ensure mechanically sufficient joint strength. Moreover, the jointed portion can be insulated from the external air and a corrosive solvent can be prevented from penetrating into the jointed portion, Therefore, corrosion of the jointed portion caused by the local cell effect can be effectively suppressed to have a high joint reliability (or long-term joint stability).

### BRIEF DESCRIPTION OF THE DRAWINGS

Next, the present invention will be explained in more detail in conjunction with appended drawings, wherein:

FIG. 1 is a perspective view showing an electrode lead connection body in a first embodiment of the present invention;

FIG. 2 is a cross sectional view taken along the line A-A of FIG. 1;

FIG. 3 is a perspective view showing a nonaqueous electrolyte electricity storing device using the electrode lead connection body of FIG. 1;

FIG. 4 is a perspective view showing an electrode lead connection body in a second embodiment of the invention;

FIG. 5 is a cross sectional view taken along the line B-B of FIG. 4;

FIG. 6 is a partially cross-sectional view showing a nonaqueous electrolyte electricity storing device using the electrode lead connection body of FIG. 4; and

FIG. 7 is a plan view showing the nonaqueous electrolyte electricity storing device using the electrode lead connection body of FIG. 4.

### DESCRIPTION OF THE PREFERRED EMBODIMENTS

Preferred embodiments of the invention will be described below in conjunction with the appended drawings.

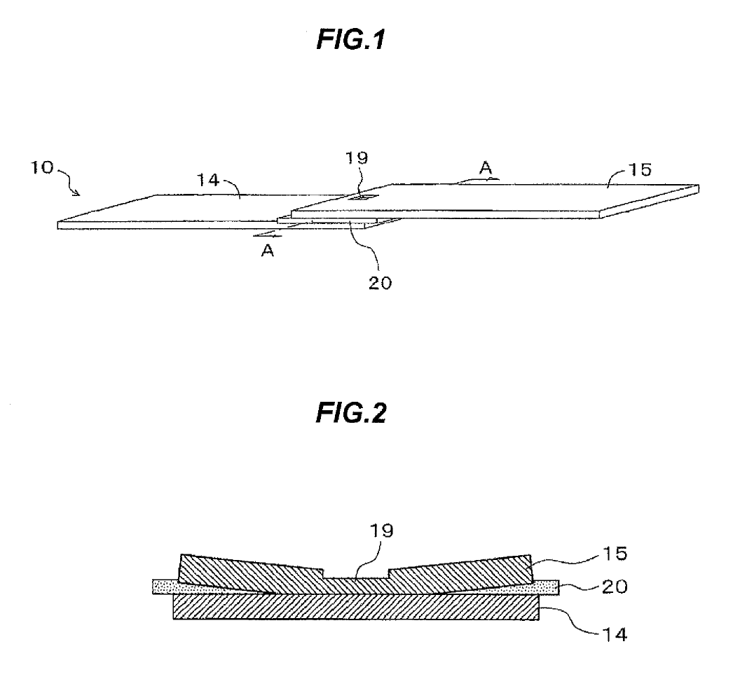

As shown in FIGS. 1 to 3, an electrode lead connection body 10 in the first embodiment is arranged between a positive electrode lead 12 connected to a positive electrode of one battery cell 11 and a negative electrode lead 13 connected to a negative electrode of another battery cell 11 different from the one battery cell and formed of a metal different from the positive electrode lead 12 so as to electrically connect the positive electrode lead 12 to the negative electrode lead 13, and is provided with a first member 14 formed of the same metal as the positive electrode lead 12 and to be connected thereto and a second member 15 formed of the same metal as the negative electrode lead 13 and to be connected thereto. The first member 14 of the electrode lead connection body 10 is joined to the positive electrode lead 12 connected to the positive electrode of the battery cell 11 (a positive electrode joint 16) and the second member 15 is joined to the negative electrode lead 13 connected to the negative electrode (a negative electrode joint 17), thereby obtaining a nonaqueous electrolyte electricity storing device 18.

In the battery cell 11, the positive electrode is formed of Al and the negative electrode is formed of Cu. Meanwhile, the positive electrode lead 12 is formed of Al or an alloy thereof and the negative electrode lead 13 is formed of Cu, Ni or Ni-plated Cu.

The metal constituting the first member 14 and that constituting the second member 15 are different from each other. The first member 14 is formed of the same metal as the positive electrode lead 12 and the second member 15 is formed of the same metal as the negative electrode lead 13. In other words, the first member 14 is formed of Al and the second member 15 is formed of Cu, Ni or Ni-plated Cu.

The first member 14 and the second member 15 are joined to each other at a portion excluding the positive electrode joint 16 as a portion to be joined to the positive electrode lead 12 and the negative electrode joint 17 as a portion to be joined to the negative electrode lead 13, and an insulating material 20 for preventing contact between the first member 14 and the second member 15 is provided at a position between the first member 14 and the second member 15 near the joint portion therebetween.

The insulating material 20 and the second member 15 are stacked in this order on the first member 14 and an ultrasonic joining tool (not shown) is brought into contact with the second member 15 formed of Cu, Ni or Ni-plated Cu to apply ultrasonic wave and load, thereby joining the first member 14 to the second member 15. The insulating material 20 is melted by heat generated during the ultrasonic joining and is pushed out from the center portion of a joint 19 toward a periphery thereof, and the periphery of the joint 19 is thereby filled with the insulating material 20. This insulates the joint 19 from ambient atmosphere (external air) and also prevents a corrosive solvent from entering the joint 19, and accordingly, occurrence and progress of corrosion phenomenon at the joint 19 caused by a local cell effect in the first member 14 and the second member 15 can be suppressed and high joint reliability is obtained.

An overlap margin of each member at the time of the ultrasonic joining can be appropriately changed depending on the size of the nonaqueous electrolyte electricity storing device 18 to be manufactured. In addition, it is possible to arbitrarily select the size of the tip portion of the ultrasonic joining tool (i.e., a portion serving for joining) in order to ensure desired joint strength.

It is preferable that the insulating material 20 be a thermoplastic resin having a melting point of not more than 230° C. and greater than Joule heat which is generated in the joint 19 of the electrode lead connection body 10 at the time of discharging and charging the nonaqueous electrolyte electricity storing device 18. The resins satisfying this condition include, e.g., polyolefin resins such as polypropylene or polyester but it is possible to select any resins as long as the above-mentioned condition is satisfied.

When the melting point of the insulating material 20 is lower than Joule heat generated in the joint 19, the insulating material 20 melts at the time of discharging and charging the nonaqueous electrolyte electricity storing device 18, and accordingly, it is not possible to insulate the joint 19 from the external air and an effect of suppressing progress of corrosion is not obtained. Since Joule heat generated in the joint 19 depends on capacity of the battery cell 11, i.e., the maximum value of current flowing through the electrode lead connection body 10, the type of the insulating material 20 is appropriately selected depending on the battery cell 11 using thereof.

Meanwhile, when the melting point of the insulating material 20 is higher than 230° C., it is not possible to melt the insulating material 20 by heat generated at the time of ultrasonic joining and electric connection between the first member 14 and the second member 15 may not be enough. This is because temperature of heat generated at the time of ultrasonic joining is generally 35 to 50% of a melting point of a metal to be joined and is thus considered to be not less than 230° C. since the melting point of Cu is 1080° C. and that of Al is 660° C. That is, the melting point of the insulating material 20 is defined to be not more than 230° C. so that the insulating material 20 is melted even at 230° C. as the minimum temperature of heat generated at the time of ultrasonic joining.

Furthermore, a voltage monitoring lead wire (not shown) which is formed of the same metal as the first member 14 or the second member 15 may be connected thereto. Since connection of the electrode lead connection body 10 to the lead wire formed of the same metal allows a more general and highly productive method, e.g., resistance welding to be adopted and also occurrence of corrosion phenomenon at the joint 19 caused by a local cell effect can be suppressed, high joint reliability is obtained.

As explained above, in the electrode lead connection body 10 of the first embodiment, since the first member 14 and the second member 15 are joined to each other at a portion excluding the positive electrode joint 16 and the negative electrode joint 17, it is possible to ensure mechanically sufficient joint strength. In addition, since the insulating material 20 is interposed between the first member 14 and the second member 15 so that the first member 14 does not contact with the second member 15 except at the joint 19, the joint 19 is insulated from the external air and a corrosive solvent is prevented from entering the joint 19, and accordingly, corrosion of the joint 19 caused by the local cell effect can be effectively suppressed and high joint reliability (long term joint stability) is obtained.

Next, the nonaqueous electrolyte electricity storing device 18 using the electrode lead connection body 10 will be described.

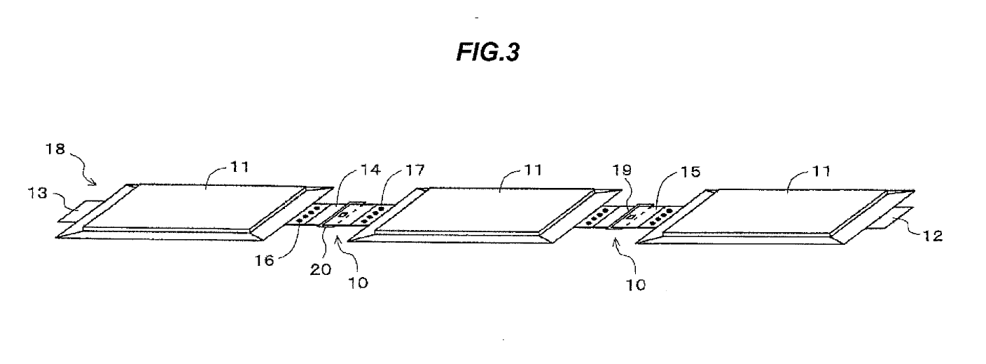

As shown in FIG. 3, the nonaqueous electrolyte electricity storing device 18 is provided with the electrode lead connection bodies 10 and plural battery cells 11 each having the positive electrode lead 12 and the negative electrode lead 13. The plural battery cells 11 are connected in series (or may be connected in parallel) by connecting the first member 14 of the electrode lead connection body 10 to the positive electrode lead 12 of one battery cell 11 and the second member 15 of the electrode lead connection body 10 to the negative electrode lead 13 of another battery cell 11, thereby manufacturing the nonaqueous electrolyte electricity storing device 18. Here, the positive electrode lead 12 is formed of Al, etc., and the negative electrode lead 13 is formed of Cu, Ni or Ni-plated Cu, etc.

The battery cell 11 may be a lithium-ion secondary battery. The battery cell 11 is a laminated battery cell in which an electrode group formed by stacking a positive electrode formed of Al and a negative electrode formed of Cu with a separator interposed therebetween is sealed and packed together with an electrolytic solution in an outer package formed of an aluminum laminated film, and the positive electrode lead 12 and the negative electrode lead 13 previously mentioned sticking out from the battery cell 11.

When connecting the plural battery cells 11 by the electrode lead connection body 10, the portions formed of the same metal are joined to each other. In other words, the first member 14 is joined to the positive electrode lead 12 and the second member 15 is joined to the negative electrode lead 13. Since the metals to be joined are the same, it is possible to select a high-speed and low-cost joining method such as, e.g., resistance welding (spot welding). In addition, there is no concern about the problem of corrosion at the positive electrode joint 16 and the negative electrode joint 17 in the case of using the same metal. Therefore, it is possible to secure connection between the plural battery cells 11 by using the electrode lead connection bodies 10.

Note that, when a voltage monitoring lead wire is connected at the time of manufacturing the electrode lead connection body 10, it is not necessary to newly install wiring at the time of assembling the nonaqueous electrolyte electricity storing device 18 and it is thereby possible to simplify the assembly process of the nonaqueous electrolyte electricity storing device 18.

Accordingly, in the nonaqueous electrolyte electricity storing device 18, since the electrode lead connection body 10 using the first member 14 and the second member 15 which are formed of the same metals respectively as the positive electrode lead 12 and the negative electrode lead 13 of the battery cell 11 is used for connecting the battery cells 11 to each other, corrosion due to the local cell effect does not occur at the positive electrode joint 16 and the negative electrode joint 17. Therefore, it is possible to secure connection of the nonaqueous electrolyte electricity storing device 18 and, further, to realize simplification of the assembly process thereof.

In addition, the problems concerned in the JP-A-2008-108584, which are insufficient sealing properties of the outer package due to the thick thermally sealed portion of the outer package and leakage of the electrolytic solution as a result, do not occur since the joint 19 is located outside of the battery cell 11 and the insulating material 20 does not overlap with the main body of the battery cell 11. Furthermore, the problem of contact between the insulating material 20 and the manufacturing tool, which occurs in Japanese patent No. 3931983, does not need to be taken into consideration since the electrode lead connection body 10 is manufactured in a separate process from the battery cell 11, and as a result, it is possible to downsize the nonaqueous electrolyte electricity storing device 18. In addition, since manufacturing the electrode lead connection body 10 and the battery cell 11 in different processes utterly prevents a manufacturing defect in the electrode lead connection body 10 from affecting the production of the battery cell 11, it is possible to reduce the manufacturing cost.

Next, an electrode lead connection body in the second embodiment of the invention and a nonaqueous electrolyte electricity storing device using the same will be described.

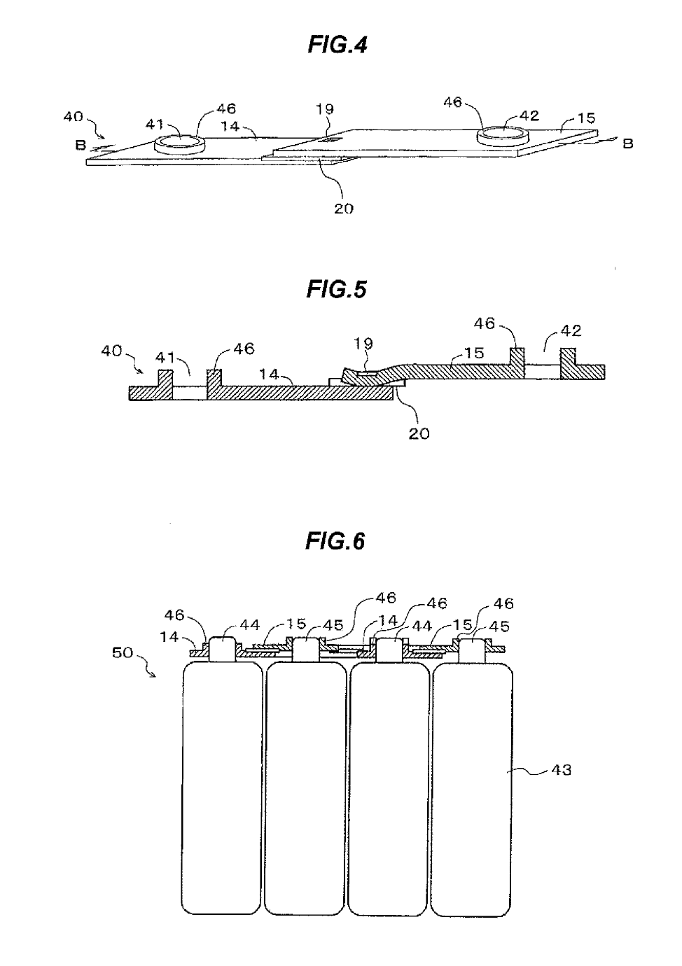

As shown in FIGS. 4 and 5, an electrode lead connection body 40 in the second embodiment is the same as the electrode lead connection body 10 in the basic structure but is different in that electrode welding holes 41 and 42 are respectively formed on the first member 14 and the second member 15 by, e.g., press working and protruding portions 46 are provided at rims of the electrode welding holes 41 and 42. In this regard, the electrode welding holes 41 and 42 may penetrate through as shown in FIGS. 4 and 5 or may be closed at an edge of the protruding portion 46 on the protruding side.

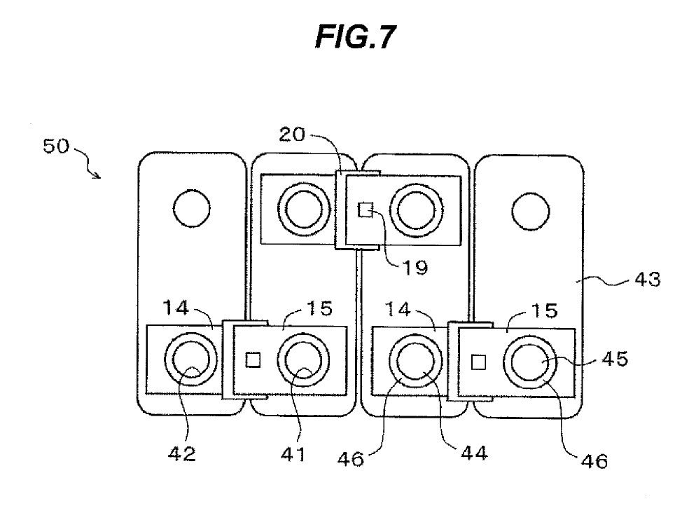

As shown in FIGS. 6 and 7, the electrode lead connection body 40 is used for connecting electrode terminals (positive terminal 44 or negative terminal 45) of prismatic battery cells 43 to form a nonaqueous electrolyte electricity storing device 50. The positive terminal 44 of the prismatic battery cell 43 is inserted into the electrode welding hole 41 of the first member 14 and is joined by welding to a side face of the protruding portion 46 of the electrode welding hole 41. Meanwhile, the negative terminal 45 is inserted into the electrode welding hole 42 of the second member 15 and is joined by welding to a side face of the protruding portion 46 of the electrode welding hole 42. Since an adequate welding margin can be provided by forming the protruding portions 46 of the electrode welding holes 41 and 42, it is possible to obtain a good welded state, which allows secure connection.

Conventionally, electrodes of a prismatic battery cell are electrically connected by a mechanical fastening mechanism, such as bolt, using a single metal material such as Ni.

When connecting by a fastening mechanism, there are problems that it is difficult to downsize a battery system due to mechanical and operational restrictions and electrical connection is unstable due to looseness of the fastening mechanism caused by vibration in the case of being mounted on a vehicle.

Although welding is a joining method which solves such problems, there are problems of selection of welding conditions and occurrence of a local cell effect due to dissimilar metal joint since the positive terminal 44 of the prismatic battery cell 43 is formed of Al and the negative terminal 45 is formed of Cu.

On the other hand, in the electrode lead connection body 40 of the second embodiment, the first member 14 formed of Al, etc., is joined to the second member 15 formed of Cu, Ni or Ni-plated Cu, etc., by ultrasonic joining via the insulating material 20 sandwiched therebetween, and accordingly, the periphery of the joint 19 between the first member 14 and the second member 15 is filled with the insulating material 20. Therefore, the joint 19 is insulated from the external air and a corrosive solvent is prevented from entering the joint 19, which allows the local cell effect to be suppressed. At the same time, it is also possible to improve weldability to the positive terminal 44 and the negative terminal 45 of the prismatic battery cell 43 since the electrode welding holes 41 and 42 each having the protruding portion 46 are formed on the first member 14 and the second member 15.

### EXAMPLES

Examples 1 and 2 of the electrode lead connection body of the invention and the nonaqueous electrolyte electricity storing device assembled using the same will be described below.

### Example 1

An Al plate having a thickness of 0.3 mm, a width of 30 mm and a length of 50 mm was used as the first member of the electrode lead connection body and a Cu plate having the same size as the first member was used as the second member.

The first and second members were stacked with an overlap margin of 10 mm via a polypropylene-based thermoplastic resin film sandwiched therebetween so that the second member is arranged on the top, and were joined by applying ultrasonic wave as well as load from the second member formed of the Cu plate.

Battery cells of lithium-ion secondary batteries were connected using this electrode lead connection body. In the battery cell, a positive electrode using Al, a negative electrode using Cu, a separator and an electrolytic solution are sealed in a rectangular outer package formed of an aluminum laminated film, and a positive electrode lead formed of Al and a negative electrode lead formed of Cu are respectively sticking out from both short sides of the battery cell.

For each electrode connection between the electrode lead connection body and the battery cell, resistance welding (spot welding) was used to weld the positive electrode lead of the battery cell to the first member and the negative electrode lead of the battery cell to the second member.

### Example 2

An Al plate having a thickness of 0.3 mm, a width of 30 mm and a length of 50 mm was used as the first member of the electrode lead connection body and a Cu plate having the same size as the first member was used as the second member.

The first and second members were stacked with an overlap margin of 10 mm via a polypropylene-based thermoplastic resin film sandwiched therebetween so that the second member is arranged on the top, and were joined by applying ultrasonic wave as well as load from the second member formed of the Cu plate. In addition, electrode welding holes and protruding portions at rims thereof were formed on the first and second members by press working.

Battery cells of lithium-ion secondary batteries were connected using this electrode lead connection body. In the battery cell, a positive electrode using Al, a negative electrode using Cu, a separator and an electrolytic solution are sealed in a square can-shaped outer package, and a positive electrode lead formed of Al and a negative electrode lead formed of Cu are sticking out from one side of the battery cell.

For each electrode connection between the electrode lead connection body and the battery cell, the positive and negative terminals of the battery cell were respectively inserted into the electrode welding holes formed on the first and second members, and resistance welding (spot welding) was used to weld the positive terminal of the battery cell to the protruding portion of the electrode welding hole formed on the first member and the negative terminal of the battery cell to the protruding portion of the electrode welding hole formed on the second member.

This structure does not require any work on the main body of the battery cell at the time of connecting the electrode lead connection body of the invention to the positive and negative electrode leads of the laminated battery cell, i.e., it is possible to obtain stable sealing properties during the thermal sealing process since the portion where the electrode lead of the battery cell is sealed with an aluminum laminated film has a simple structure such that only electrode leads are sticking out, and it is possible to maintain high production yield of the battery cell and, further, to downsize the nonaqueous electrolyte electricity storing device while contributing to simplification of manufacturing.

In addition, since it is possible to connect the electrode lead connection body of the invention to the positive and negative terminals of the prismatic battery cell only by respectively inserting the positive and negative terminals of the prismatic battery cell into the electrode welding holes of the first and second members and then carrying out resistance welding, connection is simple. Furthermore, since it is possible to provide an adequate welding margin by proving the protruding portion to the electrode welding hole, it is possible to obtain a good welded state, which allows secure connection. In addition, since looseness, which is one of the conventional problems caused by using a fastening mechanism such as bolt, does not occur, it is possible to secure connection. Furthermore, since there is no mechanical and operational restriction as another problem, it is possible to downsize the nonaqueous electrolyte electricity storing device.

Although the invention has been described with respect to the specific embodiments for complete and clear disclosure, the appended claims are not to be therefore limited but are to be construed as embodying all modifications and alternative constructions that may occur to one skilled in the art which fairly fall within the basic teaching herein set forth.

What is claimed is:

1. An electrode lead connection body for being arranged between a positive electrode lead and a negative electrode lead to electrically connect the positive electrode lead and the negative electrode lead such that the positive electrode lead is connected to a positive electrode of one battery cell and the negative electrode lead is connected to a negative electrode of another battery cell different from the one battery cell, the negative electrode lead comprising a metal different from the positive electrode lead, the electrode lead connection body comprising:
a first member that comprises a same material as the positive electrode lead and is configured to be connected the positive electrode lead;
a second member that comprises a same material as the negative electrode lead and is configured to be connected the negative electrode lead, the first and second members being joined to each other at a portion excluding a positive electrode joint as a portion to be joined to the positive electrode lead and a negative electrode joint as a portion to be joined to the negative electrode lead; and
an insulating material at a position between the first and second members and near a joint portion to join the first and second members so as to prevent a contact between the first and second members.

2. The electrode lead connection body according to claim 1, wherein the first and second members each comprise an electrode welding hole and a protruding portion provided at a rim of the electrode welding hole.

3. The electrode lead connection body according to claim 1, wherein the first member comprises Al, and the second member comprises Cu, Ni or Ni-plated Cu.

4. A nonaqueous electrolyte electricity storing device, comprising:
the electrode lead connection body according to claim 1; and
a plurality of battery cells each having a positive electrode lead and a negative electrode lead,
wherein the plurality of battery cells are connected such that the first member of the electrode lead connection body is joined to the positive electrode lead of one battery cell and the second member of the electrode lead connection body is joined to the negative electrode lead of another battery cell different from the one battery cell.

5. A method of manufacturing a nonaqueous electrolyte electricity storing device, comprising:
joining the first member of the electrode lead connection body according to claim 1 to the positive electrode lead of one battery cell and joining the second member of the electrode lead connection body to the negative electrode lead of another battery cell different from the one battery cell so as to connect a plurality of battery cells.

6. A method of manufacturing a nonaqueous electrolyte electricity storing device, comprising:
inserting a positive terminal of one battery cell into an electrode welding hole provided on the first member of the electrode lead connection body according to claim 1 and inserting a negative terminal of another battery cell different from the one battery cell into an electrode welding hole provided on the second member of the electrode lead connection body; and
welding to the positive terminal and the negative terminal a side surface of a protruding portion provided at a rim of the electrode welding holes, respectively, so as to connect a plurality of battery cells.
